(19) United States
(12) Patent Application Publication
(10) Pub. No.: US 2020/0151821 A1
(43) Pub. Date: May 14, 2020

(54) SMART RESERVE SYSTEM (SRS) FOR USE WITH A DATA-DRIVEN, ARTIFICIAL-INTELLIGENCE-INFORMED, TRANSACTION ECOSYSTEM

(71) Applicant: Bank of America Corporation, Charlotte, NC (US)

(72) Inventors: Anamika Singhal, Frisco, TX (US); Sushmitha Tadepalli, Irving, TX (US); Manu Kurian, Dallas, TX (US)

(21) Appl. No.: 16/188,773

(22) Filed: Nov. 13, 2018

(51) Int. Cl. G06Q 40/06; H04L 29/08; G06Q 50/00; G06N 20/00

(52) U.S. Cl. CPC G06Q 40/06; G06N 20/00; G06Q 50/01; H04L 67/306

(57) ABSTRACT

Aspects of the disclosure relate to methods for use with a data-driven, artificial-intelligence-informed, transaction ecosystem. Such methods may include storing profile information associated with a plurality of subscribers. The profile information may include a reserve associated with each subscriber. The method may further include using a subscriber profile control apparatus to update each subscriber profile by receiving additional subscriber information from each subscriber; receiving social media access information from each subscriber; obtaining social media information corresponding to the social media access information associated with each subscriber; modifying the subscriber profile based on the social media information; and weighting the subscriber profile information based on the social media information. The method may also include providing secure, on-demand, access to the subscriber database. The providing may use a third party access appliance. The third party access appliance may enable augmentation of the reserve associated with one or more of the subscribers.

### FIELD OF TECHNOLOGY

Aspects of the disclosure relate to transaction ecosystems. Specifically, aspects of the disclosure relate to a data-driven, artificial-intelligence-informed, transaction ecosystem.

### BACKGROUND OF THE DISCLOSURE

Corporate entities, and even individuals, often pursue differing approaches to fund their business ventures. However, these approaches often fail. These approaches may fail because of lack of transparency into an individual or individual entity's business venture and/or personal affairs/finances.

It is this lack of transparency that make an investor reluctant to invest. Conversely, greater transparency of an individual or individual entity's business venture and/or personal affairs/finances may motivate an investor to invest in an individual or individual entity's business venture. In fact, such transparency may increase the ability of the investor to properly calculate the potential success associated with the individual or individual entity's business venture.

Moreover, a clear picture of an individual's personal history and/or an individual entity's business venture's history would no doubt inform an investor's decision-making process.

Accordingly, it would be desirable to provide systems and methods that provide greater transparency of an individual or individual entity's business venture and/or personal affairs/finances.

It would be further desirable to provide systems and methods that present a clear picture of an individual's personal history and/or an individual entity's business venture's history that would no doubt inform an investor's decision-making process.

It would be yet further desirable to enable an investor to pre-set certain conditions relating to an individual's personal and/or an individual entity's business venture's such that, satisfaction of the pre-set conditions triggers an investment by the investor.

### SUMMARY OF THE DISCLOSURE

Aspects of the disclosure relate to a smart reserve system (SRS) for use with a data-driven, artificial-intelligence-informed, transaction ecosystem. The SRS may include a subscriber database. The subscriber database may store profile information associated with a plurality of subscribers. The profile information typically includes a reserve associated with each subscriber. The SRS may also include a subscriber profile control apparatus. The subscriber profile control apparatus may be configured to receive subscriber information from each subscriber. The subscriber profile control apparatus may be configured to receive social media access information from the subscriber. Once the subscriber profile control apparatus receives the social media access information, the subscriber profile control apparatus may obtain social media information corresponding to the social media access information. Based at least in part on the subscriber profile information, the subscriber profile control apparatus may form a subscriber profile. The subscriber profile control apparatus may weight the subscriber profile based on the social media information. The SRS may also include a third party access appliance. The third party access appliance may provide secure, on-demand, access to the subscriber database. The access may enable augmenting the reserve associated with one or more of the plurality of subscribers.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 shows an illustrative flow chart in accordance with subject matter regarded as inventive;

FIG. 2 shows a schematic architecture of a smart reserve system (SRS) for use with a data-driven, artificial-intelligence-informed, transaction ecosystem;

FIG. 3 shows an illustrative flow chart of the interface between the user information and social media information, involving crawling of the system for key words, which triggers the weighting of the profile according to certain criteria, and subsequent modification of the profile; and

FIG. 4 shows an illustrative flow chart of the interface between the user information and social media information, involving additional interface, such as questionnaires, whose responses trigger the weighting of the profile according to the nature of said responses, and subsequent modification of the profile.

### DETAILED DESCRIPTION OF THE DISCLOSURE

Aspects of the disclosure relate to a smart reserve system (SRS) for use with a data-driven, artificial-intelligence-informed, transaction ecosystem. The SRS includes a subscriber database (referred to herein in the alternative as a “subscriber entity database.”) The subscriber entity database is preferably configured for storing entity profile information associated with a plurality of subscribers. The entity profile information includes a plurality of constituent components (referred to herein, in the alternative, as “constituents”). One of the plurality of constituents may include a reserve value associated with each subscriber entity.

The SRS may also include a subscriber entity profile control apparatus. The subscriber profile control apparatus may be configured to receive subscriber entity information from each subscriber entity.

The subscriber profile control apparatus may be further configured to receive social media access information, such as passwords, keywords, usernames, personal identification numbers (pins), etc., from the subscriber entity. Once the subscriber profile control apparatus receives social media access information, it may then use the access information to obtain the social media access information.

In certain embodiments, the subscriber profile control apparatus may also obtain social media information other than social media information corresponding to the social media access information. The social media information other than social media information corresponding to the social media access information may relate to the entity. Yet, the subscriber control apparatus may, in certain embodiments, not require the social media access information to retrieve the other social media information.

In certain embodiments, the subscriber profile control apparatus may form a subscriber entity profile based on the subscriber entity profile information. In some embodiments, the subscriber profile control apparatus may weight the subscriber entity profile based on the social media information and on the social media information other than social media information corresponding to the social media access information.

The SRS may also include a third party access appliance. The third party access appliance may be configured for providing secure, on-demand, access to the subscriber entity database. The access may provide access to constituents used by the SRS to determine the weight of the profile. In certain embodiments, the third party access appliance may include a graphical user interface (“GUI”) for enabling access to the subscriber entity database.

In some embodiments, the SRS may leverage artificial intelligence to enhance the access provided using the third party access appliance. The artificial intelligence may be configured to retrieve historical social media information. The artificial intelligence may also be configured to correlate the historical social media information with historic profile information. The correlating the historical social media information with historic profile information may include retrieving discrete social media event reports. The correlating may correlate the discrete social media event reports with cognizable profile variants. Such variants may include the financial success and/or failure, on a macro scale and/or on a micro scale, of the entity.

In one specific example, the specific social media event reports may relate to milestone events such as level of received funding, passage of governmental tests such as Food and Drug Administration milestones, sales milestones, etc. In some examples, the specific social media event reports may relate to personal milestone events such as bankruptcies, marriages, divorces, birth of children, death in the family, etc.

Such events may correlate to changes in percentage success or failure of the cognizable variants described above. Furthermore, the artificial intelligence may weight the profile information in response to, or as part of, the analysis of the correlations discussed above. Accordingly, the artificial intelligence may mine the social media information to either weight the profile in a way that is more favorable or less favorable to a third party accessor. The determination of favorability will depend, at least in part, on the analysis of the social media information derived from the social media sources.

In certain embodiments, the third party access appliance may include a unidirectionally-initiatable, and/or unidirectionally-maintainable, communication platform. Using such a platform, one or more of the plurality of third parties may initiate communication with a selected subscriber. The characterization of the communications platform as unidirectionally-initiatable, and/or unidirectionally-maintainable, preferably protects a third party from solicitations by one or more of the subscribers and/or subscriber entities.

In other embodiments, the third party access appliance may provide a bi-directional transaction platform for one or more of a plurality of third parties to transact with a selected subscriber. In such instances, the transaction platform may require consent from the third party to initiate a transaction negotiation. Accordingly, the platform may, in certain embodiments, be unidirectionally-initiatable by the third party. Once initiated, however, the transaction platform may preferably be maintainable and/or open to communication from both parties. In such embodiments, the platform may enable a third party to invest in one or more of the subscribers and/or subscriber entities. Such investment may include adding to the reserve associated with the subscribers and/or subscriber entities.

Such a transaction may include the third party funding of a selected subscriber entity. In certain embodiments, the third party access appliance may be pre-configured to fund the selected subscriber entity if certain milestones are achieved by the selected subscriber, certain thresholds are traversed (such as web traffic levels, funds level in the selected subscriber's reserve are achieved), certain obstacles are overcome, etc.

In a more particular embodiment, one or both parties may be able to “transfer” or “share” ownership of their respective ownership rights with the other entity to the transaction. For example, if a young adult ‘A’ saving for purchase of an automobile reaches 70% of a pre-determined threshold savings amount, the seller ‘B’ may offer a discount at a milestone of 80% of the original sales price in order to motivate the purchaser to complete the sale.

At that point, ‘A’ can ask a parent ‘C’ to join in with the additional 10% necessary to complete the discounted sale. In addition, ‘C’ may even add an additional 15% to qualify for added value or other relevant option or options.

In another example, a positive result retrieved from a web crawl (a graduation of a grandson, a success in a debate or other competition, etc.) may trigger a reward. Such a reward may be triggered in the case of an educational foundation that rewards students for and/or other candidates for reported successes. In such systems, the system may monitor for certain academic goals and, at each point of pre-determined success metrics, award a certain marked value to a goal. On a contrary note, the system could reduce pending awards in response to a negative result from a web crawl (an arrest, a bankruptcy, or other negative response).

In certain embodiments, a combination of the foregoing may be incorporated into a single system. In such a combined system, a user may have his purchase aided by a second party. In addition, the second party may provide additional aid in response to web-crawling that retrieves various positive responses regarding the target of the crawling.

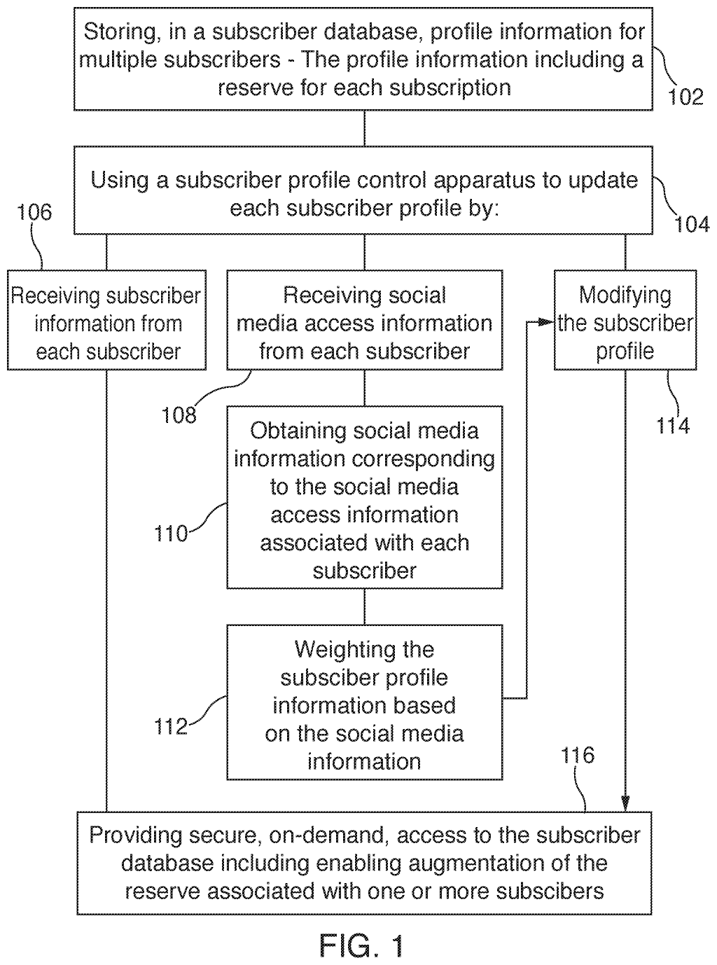

Specifics of a shared ecosystem according to certain embodiments follow. The embodiments are described in conjunction with FIGS. 1-4.

FIG. 1 shows an illustrative flow chart in accordance with subject matter regarded as inventive. Step 102 in FIG. 1 shows a subscriber database storing profile information for multiple subscribers-the profile information including a reserve for each subscription. Step 104 shows a subscriber profile control apparatus to update each subscriber profile in one of the following manners: Step 106 shows an independent input apparatus which receives subscriber information from each subscriber. Step 108 shows an independent input apparatus that receives social media access information from each subscriber. Step 110 shows interface with social media information corresponding to the social media access information associated with each subscriber. Step 112 shows the weighting of the subscriber profile information based on the social media information. Step 114 shows modifying the subscriber profile based on the subscriber profile information. Step 116 shows providing secure, on-demand access to the subscriber database including enabling augmentation of the reserve associated with one or more subscribers.

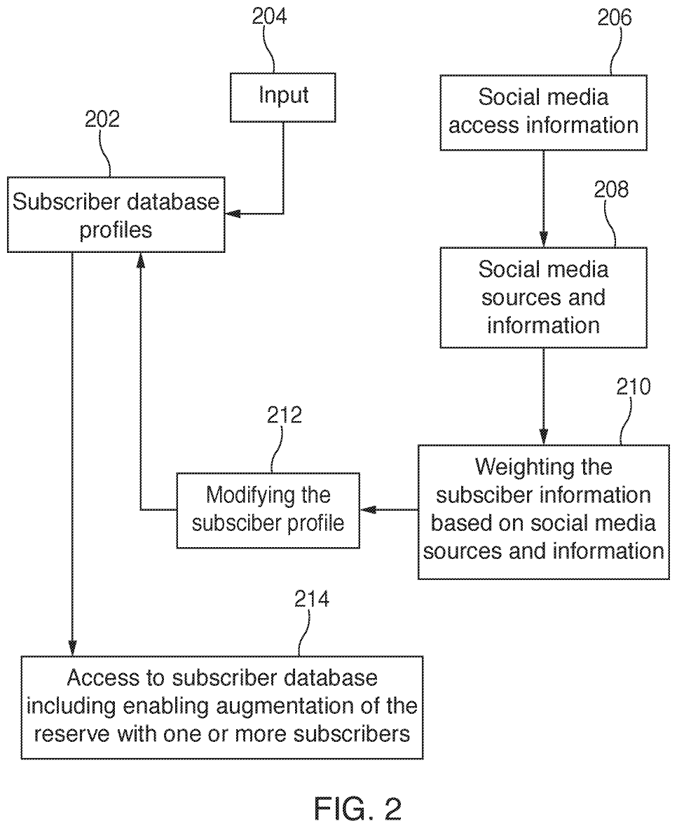

FIG. 2 shows a schematic architecture of a smart reserve system (SRS) for use with a data-driven, artificial-intelligence-informed, transaction ecosystem. Step 202 shows subscriber database profiles with a reserve for each subscription.

Step 204 shows an independent input apparatus which receives subscriber information from each subscriber. Step 206 shows an independent input apparatus which receives social media access information from each subscriber. Step 208 shows interface between the independent input apparatus and social media sources that identify the subscriber and the associated information. Step 210 shows weighting of the subscriber profile information based on criteria culled from the social media information. Step 212 shows the modification of a subscriber profile based on the previously weighted information. Step 214 shows access to subscriber database including enabling augmentation of the reserve with one or more subscribers.

The steps of methods may be performed in an order other than the order shown and/or described herein. Embodiments may omit steps shown and/or described in connection with illustrative methods. Embodiments may include steps that are neither shown nor described in connection with illustrative methods.

Illustrative method steps may be combined. For example, an illustrative method may include steps shown in connection with another illustrative method.

Apparatus may omit features shown and/or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

The drawings show illustrative features of apparatus and methods in accordance with the principles of the invention. The features are illustrated in the context of selected embodiments. It will be understood that features shown in connection with one of the embodiments may be practiced in accordance with the principles of the invention along with features shown in connection with another of the embodiments.

One of ordinary skill in the art will appreciate that the steps shown and described herein may be performed in other than the recited order and that one or more steps illustrated may be optional. The methods of the above-referenced embodiments may involve the use of any suitable elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

Thus, methods and systems for providing a shared ecosystem for document authentication and authorization are provided. Persons skilled in the art will appreciate that the present invention can be practiced by other than the described embodiments, which are presented for purposes of illustration rather than of limitation, and that the present invention is limited only by the claims that follow.

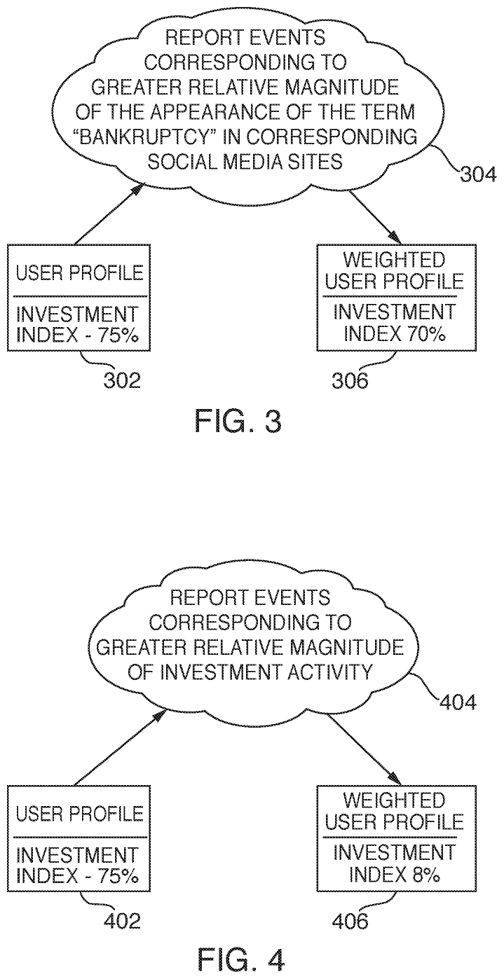

FIG. 3 is an example of how a user profile is weighted according to set criteria. In this example, the set criteria is modified based, at least in part, on information culled from social media. Step 302 shows input into the system of a user profile with an investment index rating of 75%.

Step 304 demonstrates the crawling of the user's social media information, specifically a search for the key word “Bankruptcy.” In step 306, the user profile is weighted based on the amount of times the term “BANKRUPTCY” appears as associated with the user information on social media. The investment index is then modified, in this case lowered, accordingly.

The method in FIG. 3 can also be used to affect an actual transaction or approval to transact.

For example, a syndicate group of investors may seek additional venture capital for a particular investment. The group can use the system to vet additional investors to bring additional capital to the group.

Further in the example, a user profile of a prospective additional investor is entered into the system, as shown in step 302.

Next, as shown in step 304, the user's social media information is crawled to search for keywords and criteria, such as “Annual Salary” “Capital” “High Net Worth.”

Based on the results of the crawl, the user profile is weighted, and subsequently modified, accordingly, as shown in step 306.

For example, a user may have an initial investment index rated at 75%, as shown in step 302.

The system will then be crawled, as shown in 302, and the results of the crawl may show items, such as “recent inheritance” and “high net worth club.”

The user profile will then be weighted by incorporating the data culled from social media during the crawl. Such items as “recent inheritance” and “high net worth club” will ultimately cause the investment index to be raised. The user profile will be modified.

If the modification causes the index number to reach a certain threshold, the user may receive an offer to invest in a particular venture and be offered a syndicate interest in a particular deal.

The offer may be automatic and/or followed up by additional contact. In certain embodiments, there may be no obligation on the part of the user.

The arrangements will be greatly expedited since the investor has already been vetted by the system.

FIG. 4 is another example of how a user profile is weighted and modified based on interface between the user profile information and social media information. Step 402 shows input into the system of user profile with an investment index rating of 75%.

Step 404 shows the tracking of social media information for investment activity. Such tracking can involve a questionnaire or series of questions that cull answers from social media information. The responses to the questions will trigger the weighting of the user profile based on the content of the responses, as shown in step 406. The investment index rating is then modified based on the weighting, in this case raised.

The method in FIG. 4 can also be used to trigger an actual sale or approval for sale. For example, a consumer can apply to purchase a car from a dealer, using this system. As shown in step 402, the user profile would be entered into the system.

As shown in step 404, the system would then prompt a series of questions directed to net worth, such as equity questions, cash and savings questions, whose answers will be culled from social media information.

The user profile will then be weighted based on the answers to the questions, and ultimately modified, accordingly, as shown in step 406.

If after the modification, the user profile reaches a certain threshold index number, an actual sale or offer sale can be affected.

For example, a car salesman can use the system to assess the fiscal integrity of a potential consumer.

The user profile of a potential consumer is entered into the system, as shown in step 402. Next the system generates questions regarding credit scores, net worth, income, outstanding loans, etc., whose answers are culled from social media information, as shown in step 404.

The user profile will be weighted according to the culled information, and subsequently modified, accordingly.

If the profile investment index reaches a certain threshold number, a customized offer to purchase the car, based at least in part on the achieved threshold of the investment profile index, will be immediately sent to the person, followed up by additional contact.

In certain embodiments, the user may not be bound by the offer to purchase or approval to purchase.

If the consumer wishes to purchase the car, the deal will be greatly expedited because preliminary inquiries that led to the profile rating, have been completed.

It should be noted that the amount of the weight in response to the events culled from social media may preferably be artificial-intelligence based. For example, the amount of the weight applied may correspond to a review of historical events that correspond to the culled events. Such a review may encompass determining the historical change to the individual or entity pursuant to the historical notation of the events. Such a review may then be used to adjust the current investment index either higher or lower.

The steps of methods may be performed in an order other than the order shown and/or described herein. Embodiments may omit steps shown and/or described in connection with illustrative methods. Embodiments may include steps that are neither shown nor described in connection with illustrative methods.

Illustrative method steps may be combined. For example, an illustrative method may include steps shown in connection with another illustrative method.

Apparatus may omit features shown and/or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

The drawings show illustrative features of apparatus and methods in accordance with the principles of the invention. The features are illustrated in the context of selected embodiments. It will be understood that features shown in connection with one of the embodiments may be practiced in accordance with the principles of the invention along with features shown in connection with another of the embodiments.

One of ordinary skill in the art will appreciate that the steps shown and described herein may be performed in other than the recited order and that one or more steps illustrated may be optional. The methods of the above-referenced embodiments may involve the use of any suitable elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

Thus, methods and apparatus for a smart reserve system for use with a data-driven, artificial-intelligence-informed transaction ecosystem are provided. Persons skilled in the art will appreciate that the present invention can be practiced by other than the described embodiments, which are presented for purposes of illustration rather than of limitation. The present invention is limited only by the claims that follow.

What is claimed is:

1. A smart reserve system (SRS) for use with a data-driven, artificial-intelligence-informed, transaction ecosystem, the SRS comprising:
a subscriber database, said subscriber database for storing profile information associated with a plurality of subscribers, said profile information comprising a reserve associated with each subscriber;
a subscriber profile control apparatus, said subscriber profile control apparatus configured to:
receive subscriber information from each subscriber;
receive social media access information from the subscriber;
obtain social media information corresponding to the social media access information;
form the subscriber profile based on the subscriber profile information; and
weight the subscriber profile based on the social media information;
a third party access appliance, said third party access appliance for providing secure, on-demand, access to the subscriber database, said access comprising augmenting the reserve associated with one or more of the plurality of subscribers.

2. The SRS of claim 1, wherein the artificial intelligence is configured to retrieve historical social media information.

3. The SRS of claim 2, wherein the artificial intelligence is configured to correlate the historical social media information with historic profile information.

4. The SRS of claim 3, wherein the correlating the historical social media information with historic profile information comprises retrieving discrete social media event reports and correlating the discrete social media event reports with cognizable profile variants.

5. The SRS of claim 1, wherein the third party access appliance provides access to constituents used by the SRS to determine the weight of the profile.

6. The SRS of claim 1, wherein the third party access appliance provides a unidirectionally-initiatable communication platform for one of the plurality of third parties to initiate communication with a selected subscriber.

7. The SRS of claim 1, wherein the third party access appliance provides a bidirectional transaction platform for one or more of a plurality of third parties to transact with a selected subscriber, and wherein the bidirectional transaction platform enables the one or more of a plurality of third parties to crawl the internet for information regarding the selected subscriber and to further augment the reserve in response to retrieval of predetermined event reports regarding the selected subscriber.

8. A method for use with a data-driven, artificial-intelligence-informed, transaction ecosystem, the method comprising:
storing, in a subscriber database, profile information associated with a plurality of subscribers, said profile information comprising a reserve associated with each subscriber;
using a subscriber profile control apparatus to update each subscriber profile by:
receiving additional subscriber information from each subscriber;
receiving social media access information from each subscriber;
obtaining social media information corresponding to the social media access information associated with each subscriber;
modifying the subscriber profile based on the social media information; and
weighting the subscriber profile information based on the social media information;
providing secure, on-demand, access to the subscriber database, said providing using a third party access appliance, said access comprising enabling augmentation of the reserve associated with one or more of the plurality of subscribers.

9. The method of claim 8, wherein the subscriber profile control apparatus is configured to retrieve historical social media information.

10. The method of claim 9, further comprising using the artificial intelligence to correlate the historical social media information with historic profile information.

11. The method of claim 10, further comprising retrieving discrete social media event reports and correlating the discrete social media event reports with cognizable profile variants.

12. The method of claim 8, wherein the third party access appliance provides access to constituents used by the SRS to determine the weight of the profile.

13. The method of claim 8, wherein the third party access appliance provides a unidirectionally-initiatable communication platform for one of the plurality of third parties to initiate communication with a selected subscriber.

14. The method of claim 8, wherein the third party access appliance provides a bidirectional transaction platform for one or more of a plurality of third parties to transact with a selected subscriber.

15. A smart reserve system (SRS) for use with a data-driven, artificial-intelligence-informed, transaction ecosystem, the SRS comprising:
a subscriber entity database, said subscriber entity database for storing entity profile information associated with a plurality of subscribers, said entity profile information comprising a plurality of constituents, said plurality of constituents comprising a reserve, associated with each subscriber entity;
a subscriber entity profile control apparatus, said subscriber profile control apparatus configured to:
receive subscriber entity information from each subscriber entity;
receive social media access information from the subscriber entity;
obtain social media information corresponding to the social media access information;
obtain social media information other than social media information corresponding to the social media access information;
form the subscriber entity profile based on the subscriber entity profile information; and
weight the subscriber entity profile based on the social media information and on the social media information other than social media information corresponding to the social media access information;
a third party access appliance, said third party access appliance for providing secure, on-demand, access to the subscriber entity database, said access comprising access to constituents used by the SRS to determine the weight of the profile.

16. The SRS of claim 15, wherein the artificial intelligence is configured to retrieve historical social media information.

17. The SRS of claim 16, wherein the artificial intelligence is configured to correlate the historical social media information with historic profile information.

18. The SRS of claim 17, wherein the correlating the historical social media information with historic profile information comprises retrieving discrete social media event reports and correlating the discrete social media event reports with cognizable profile variants.

19. The SRS of claim 15, wherein the third party access appliance provides a unidirectionally-initiatable communication platform for one of the plurality of third parties to initiate communication with a selected subscriber.

20. The SRS of claim 15, wherein the third party access appliance provides a bidirectional transaction platform for one or more of a plurality of third parties to transact with a selected subscriber, and wherein the bidirectional transaction platform enables the one or more of a plurality of third parties to crawl the internet for information regarding the selected subscriber and to further augment the reserve in response to retrieval of predetermined event reports regarding the selected subscriber.
